(19) United States
(12) Patent Application Publication
(10) Pub. No.: US 2010/0114421 A1
(43) Pub. Date: May 6, 2010

(54) VEHICLE

(75) Inventor: Katsunori Doi, Tokyo (JP)

Correspondence Address: BACON & THOMAS, PLLC, 625 SLATERS LANE, FOURTH FLOOR, ALEXANDRIA, VA, 22314-1176, US

(73) Assignee: EQUOS RESEARCH CO., LTD., TOKYO (JP)

(21) Appl. No.: 12/532,697

(22) PCT Filed: Feb. 22, 2008
(86) PCT No.: PCT/JP2008/053061

§ 371 Date: Dec. 31, 2009

(30) Foreign Application Priority Data
Mar. 29, 2007 (JP) 2007-089234
Mar. 29, 2007 (JP) 2007-089235
Mar. 29, 2007 (JP) 2007-089236

(51) Int. Cl. G06F 7/00

(52) U.S. Cl. 701/29; 701/49

(57) ABSTRACT

An inverted vehicle in which the angle of tilt of a vehicle body due to acceleration can be reduced by ground engagement members. The vehicle causes assist wheels to engage the ground when acceleration of the vehicle exceeds a predetermined threshold value to accelerate/decelerate the vehicle. The acceleration may be either requested acceleration or actual acceleration. The ground contact points of the assist wheels are set so that higher the acceleration, the farther away the ground contact points are from the ground contact points of the drive wheels, in the direction opposite to the direction of the acceleration. When the acceleration is within a predetermined range, the vehicle body tilts to a corresponding angle, and when the acceleration exceeds the predetermined threshold value, the assist wheels engage the ground to prevent the vehicle body from tilting beyond a predetermined value.

### TECHNICAL FIELD

The present invention relates to a vehicle, and in particular relates to a vehicle operating as an inverted pendulum for posture control, for example.

### BACKGROUND ART

Vehicles operating as an inverted pendulum for posture control (hereafter simply termed “inverted pendulum vehicles”) have attracted attention. A sensor unit provided in an inverted pendulum vehicle detects the state of balance of a housing and a transportation device is placed in a stationary or moving state by controlling the operation of a rotating body by a control unit.

JP-A-2004-74814 and JP-A-2004-217170 disclose inverted pendulum vehicles which employ retractable auxiliary wheels as a ground contact member for limiting inclination by placing a section of the vehicle body in contact with the ground.

JP-A-2004-74814 discusses facilitating the mounting and dismounting of the vehicle by a rider with ground contact of the auxiliary wheels stabilizing the vehicle posture. Furthermore the extension of the auxiliary wheels maintains the vehicle posture when the posture control encounters difficult conditions.

JP-A-2004-217170 discloses extension of the auxiliary wheels responsive to abnormal operating conditions to maintain vehicle body stability.

### DISCLOSURE OF THE INVENTION

### Problem to be Solved by the Invention

In an inverted pendulum vehicle, the vehicle body must undergo large forward and rearward inclination responsive to a request for rapid acceleration and responsive to sharp braking, in order to maintain balance in the vehicle body by tilting the vehicle body during acceleration or deceleration of the vehicle. Since the field of vision of an occupant is moved through a large vertical range, riding comfort tends to be adversely affected. However the ground contact member (auxiliary wheels) in both of the above patent documents only makes ground contact when the vehicle is stationary or during abnormal operation.

Thus, it is an object of the present invention to provide a vehicle enabling reduction of an angle of vehicle inclination in response to acceleration and deceleration by using a ground contact member.

### Means for Solving the Problem

In order to achieve the above object, the invention provides a vehicle including coaxially disposed drive wheels, a vehicle body having a riding section, acceleration request acquisition means for receiving a requested acceleration of the vehicle, running control means for maintaining the vehicle body, including the riding section, upright by controlling torque to the drive wheels and running in response to the requested acceleration, a ground contact member disposed to be switchable between a ground contact state and a non-ground contact state at a position forward or forward of the drive wheels, and ground contact member control means for extending the ground contact member into ground contact in a direction opposite to the direction of acceleration of the drive wheels when the absolute value of the requested acceleration acquired is greater than or equal to a predetermined threshold.

Preferably, the ground contact member control means places the ground contact member in ground contact at a position further away from the drive wheels as the absolute value of the requested acceleration increases.

Preferably, for the non-ground contact state, the ground contact member control means places the ground contact member in a standby position by lifting the ground contact member by a predetermined distance at a position on a vertical line passing through the rotational axis of the drive wheels, or at a ground contact position when the absolute value of the requested acceleration is a predetermined threshold.

The vehicle may further include selection means for selecting a maximum value for vehicle body angle of inclination. The ground contact member control means makes the acceleration corresponding to a maximum value of the selected vehicle body angle of inclination coincide with the predetermined threshold.

The vehicle may further include slip detecting means for detecting slip of the drive wheels when the ground contact member is in ground contact. When slip in the drive wheels is detected, the ground contact member control means displaces the ground contact member in a direction away from the drive wheels.

In another aspect, the invention provides a vehicle including coaxially disposed drive wheels, a vehicle body having a riding section, acceleration request acquisition means for receiving a requested acceleration for the vehicle, running control means for maintaining the vehicle body including the riding section in an upright state by controlling torque to the drive wheels and running in response to the requested acceleration, a ground contact member selectively movable between a ground contact state and a non-ground contact state in a position forward, or forward of the drive wheels, ground contact member control means for placing the ground contact member in ground contact in a direction opposite to the direction of acceleration of the drive wheels when the absolute value of the requested acceleration is greater than or equal to a predetermined threshold, position determination means for determining the position of the ground contact member when in the ground contact state, and correction means for correcting the requested acceleration used by the running control means to a value equal to or less than a limiting acceleration when the absolute value of the limiting acceleration corresponding to the determined position of the ground contact member is smaller than an absolute value of the requested acceleration.

In yet another aspect, the invention provides a vehicle including coaxially disposed drive wheels, a vehicle body having a riding section, acceleration request acquisition means for acquiring a requested acceleration for the vehicle, running control means for maintaining the vehicle body including the riding section in an upright state by controlling torque of the drive wheels and running in response to the requested acceleration, a ground contact member switchable between a ground contact state and a non-ground contact state in a position forward, or forward of the drive wheels, and ground contact member control means for extending the ground contact member into ground contact in a direction opposite to the direction of acceleration of the drive wheels when the absolute value of the requested acceleration acquired is greater than or equal to a predetermined threshold and when emergency braking is requested.

According to the present invention, when the absolute value of the requested acceleration is greater than or equal to a predetermined threshold, since the ground contact member is placed in ground contact in a direction opposite to the direction acceleration of the drive wheels, it is possible to reduce the angle of inclination of the vehicle body resulting from acceleration.

### BRIEF DESCRIPTION OF THE DRAWINGS

FIG. 1A and FIG. 1B are external views with occupant mounted on a vehicle according to the present embodiment.

FIG. 2 shows the constitution of the control unit.

FIGS. 3A and 3B show dynamic modes of a vehicle posture control system according to the present embodiment.

FIG. 4 is a flowchart showing a deceleration running control process according to a first embodiment.

FIG. 5 shows the relationship between a target value θ₁* for vehicle body inclination angle and a target value b* for auxiliary wheel position relative to the target value α* for deceleration.

FIG. 6 shows the constitution of the control unit according to a second embodiment.

FIG. 7 shows the relationship of an inclination angle command and a maximum vehicle body inclination angle θ_{1,Max}.

FIG. 8 is a flowchart of a deceleration running control process according to the second embodiment.

FIG. 9 is a flowchart of a deceleration running control process according to a third embodiment.

FIG. 10 is a flowchart of a deceleration running control process according to a fourth embodiment.

FIG. 11 is a flowchart of a deceleration running control process according to a fifth embodiment.

### DESCRIPTION OF THE REFERENCE NUMERALS

11 DRIVE WHEELS
12 DRIVE MOTOR
13 RIDING SECTION
14 SUPPORT MEMBER
15 ASSIST WHEELS
131 SEAT CUSHION
132 SEAT BACK
133 HEAD RESTRAINT
16 CONTROL UNIT
20 CONTROL ECU
21 MAIN CONTROL ECU
22 DRIVE WHEEL CONTROL ECU
23 ROD CONTROL ECU
30 INPUT DEVICE
31 ACCELERATION/DECELERATION COMMAND DEVICE
40 VEHICLE BODY CONTROL SYSTEM
41 ANGLE METER
50 DRIVE WHEEL CONTROL SYSTEM
51 DRIVE WHEEL ROTATION ANGLE METER
52 DRIVE WHEEL ACTUATOR
60 ROD CONTROL SYSTEM
61 ROD DRIVE MOTOR ROTATION ANGLE METER
62 ROD ACTUATOR F
63 ROD ACTUATOR R

### DESCRIPTION OF THE PREFERRED EMBODIMENTS

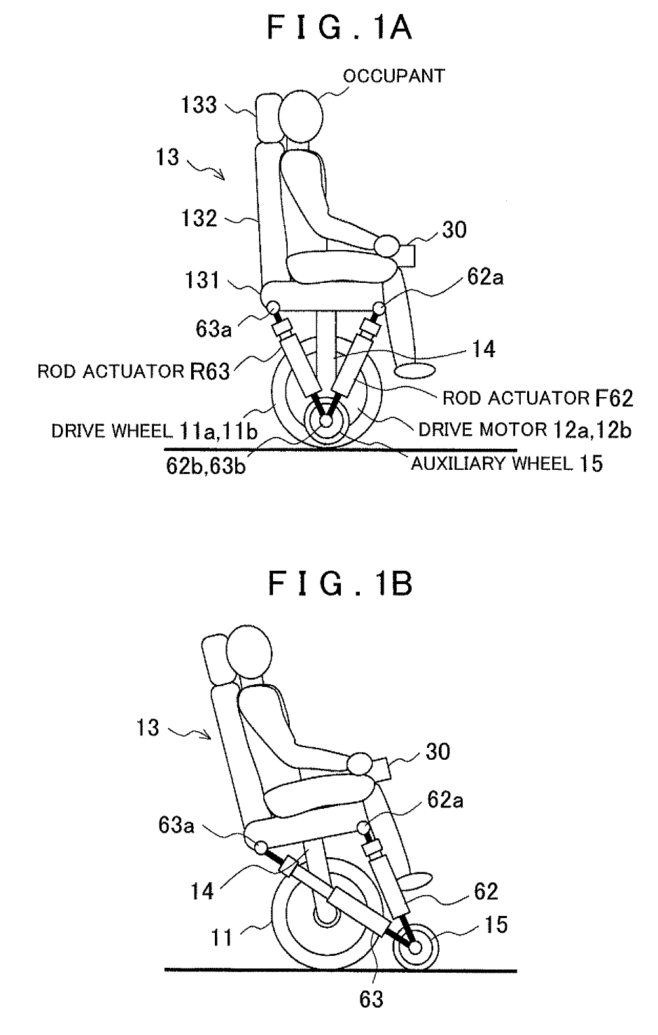

Preferred embodiments of a vehicle according to the present invention will be described with reference to FIGS. 1 to 11.

### (1) Overview of the Embodiments

A vehicle according to the present embodiment is an inverted pendulum vehicle having a structure in which the shaft of coaxially disposed drive wheels is connected with a riding section. The vehicle maintains the riding section in an upright state by using a sensor to measure the rotation of the vehicle wheels and the inclination of the vehicle body and uses the measurement value by controlling with the drive wheels.

Furthermore a moveable auxiliary wheel mechanism is provided to function as a ground contact member. The moveable auxiliary wheel mechanism is formed by auxiliary wheels, a rod actuator and a rod control ECU.

When the absolute value for acceleration exceeds a predetermined threshold during sharp acceleration or deceleration, the auxiliary wheels are placed in ground contact. Acceleration may be either requested acceleration or actual acceleration. The ground contact position of the auxiliary wheels is set to be spaced from the drive wheels (from a reference position) during acceleration, in a direction forward of the ground contact point of the drive wheels, and during deceleration, in a rearward direction, as acceleration increases.

In the vehicle according to this embodiment, both superior characteristics as an inverted pendulum vehicle and superior characteristics for auxiliary wheels are realized by placing the auxiliary wheels in ground contract at the required position at the required time.

More precisely, when the absolute value of acceleration is smaller than a predetermined threshold, vehicle body posture is maintained by displacing the center of gravity resulting from vehicle body inclination. Conversely when the absolute value of acceleration is larger than a predetermined threshold, the vehicle body is inclined to an angle of inclination corresponding to the predetermined threshold (the maximum value of the vehicle inclination) and the auxiliary wheels is displaced in contact with the ground in a direction opposite to that of acceleration in order to maintain vehicle body posture by displacement of the center of gravity resulting from vehicle body inclination and a reactive force (normal force) to the auxiliary wheels.

Although the vehicle body is inclined by an angle corresponding to a predetermined acceleration, since inclination of the vehicle body greater than or equal to the predetermined threshold is limited by the ground contact of the auxiliary wheels relative to the acceleration exceeding the predetermined threshold, an occupant experiences comfortable acceleration and deceleration.

When the auxiliary wheels make ground contact, the position of the auxiliary wheels (wheel base between the drive wheels and the auxiliary wheels) is varied to a position which maintains the minimum required ground contact load of the drive wheels in response to the dimension of the acceleration. In this manner, accurate variation in speed is realized since the ground contact load of the drive wheels is ensured.

In the present embodiment, since the auxiliary wheels do not make ground contact during acceleration and deceleration at speeds less than or equal to the predetermined threshold, energy loss resulting from shaft friction and rotational inertia caused by unnecessary ground contact by the auxiliary wheels can be reduced.

It is not always necessary to provide auxiliary wheels as a ground contact member and a curved member having a predetermined curvature on a distal portion may be placed into ground contact as a ground contact member.

Another embodiment enables variation of the degree of vehicle body inclination in response to the preference of an occupant.

Furthermore a target deceleration can be limited with respect to an actual auxiliary wheel position.

When the drive wheels slip, slip may be avoided by increasing the ground contact load of the drive wheels by increasing the separation of the auxiliary wheels.

Limiting the target deceleration with respect to an actual auxiliary wheel position eliminates the production of a large acceleration which cannot be dealt with prior to displacement of the auxiliary wheels.

Furthermore during emergency braking, running control can take priority to vehicle body posture control. In other words, during emergency braking, braking delays resulting from a rearward tilting posture due to braking can be eliminated by maintaining an upright vehicle body or by placing the auxiliary wheels in ground contact immediately while tilting the vehicle body in a direction opposite to the direction of acceleration.

FIGS. 1A and 1B show examples of an external appearance with an occupant riding a vehicle according to a first embodiment. As shown in FIG. 1A, the vehicle includes two co-axially disposed drive wheels 11a (11b). Drive wheels 11a, 11b are driven respectively by drive motors 12a, 12b. A riding section 13 (seat) for mounting an occupant or cargo (weight bodies) is disposed on an upper section of the drive wheels 11a, 11b (hereafter, the drive wheels 11a, 11b will be collectively referred to as drive wheels 11. Other components will be treated the same below) and the drive motor 12. The riding section 13 is formed from a seat cushion 131 on which a driver sits, a seat back 132 and a head restraint 133. The riding section 13 is supported by a support member 14 fixed to a drive motor housing that houses the drive motor 12.

An input device 30 is disposed on the side of the riding section 13. The input device 30 is operated by a driver to perform vehicle commands such as acceleration, deceleration, turning, stationary turning, stopping and braking. Although the input device 30 in the present embodiment is fixed to the seat cushion 131, the input device 30 may be formed by either a hard-wired or wireless remote controller. Furthermore an armrest may be provided and the input device 30 may be provided on an upper section thereof. Although the input device 30 is provided in a vehicle according to the present embodiment, when the vehicle operates automatically using pre-set running command data, a running command data readout section may be provided in substitution for the input device 30. The running command data readout section may include, for example, reading means for reading running command data from various types of memory media such as semiconductor memories and/or transmission control means for reading out running command data from an external section by wireless transmission.

FIGS. 1A and 1B show a person mounted on the riding section 13. However, the vehicle is not limited to always transporting a person and may carry only cargo and run and stop by remote control operation, for example, from an external section, carry only cargo and run and stop according to running command data, or run and stop without carrying anything. In the present embodiment, control such as acceleration or deceleration is performed by an operation signal output by operating the input device 30.

A control unit (not shown) is disposed between the riding section 13 and the drive wheels 11. The control unit in the present invention is mounted on a lower face of the seat cushion 131.

A moveable auxiliary wheel mechanism is disposed in the seat cushion 131. The moveable auxiliary wheel mechanism includes auxiliary wheels 15, rod actuator F62 and rod actuator R63.

As shown in FIG. 1A, an end 62a of one end of the rod actuator F62 is disposed in front of the seat cushion 131. The other end 62b is disposed coaxially with the rotation shaft of the auxiliary wheels 15. An end 63a of one end of the rod actuator F62 is disposed in the back of the seat cushion 131. The other end 63b is disposed coaxially with the rotation shaft of the auxiliary wheels 15. Both ends of the rod actuator F62 and rod actuator R63 are mounted rotatably with respect to the seat cushion 131 and the auxiliary wheels 15. One end 62a, 63a of both rod actuators F62, R63 may be attached rotatably with respect to another section of the vehicle body rather than the seat cushion 131, the support member 14, for example.

Both rod actuators F62, R63 have a structure in which the overall length can be varied by compression and expansion.

FIG. 1A shows a reference state, that is to say, the state in which the auxiliary wheels 15 are directly below the drive shaft of the drive wheels 11 when the vehicle body posture is upright. In contrast, FIG. 1B shows the state of both rod actuators F62, R63 and the inclination of the vehicle body during deceleration. As shown in FIG. 1B, when the absolute value of acceleration is greater than or equal to a predetermined threshold, as shown in FIG. 1B, the vehicle body is inclined rearward to an angle of inclination corresponding to the predetermined threshold (a maximum inclination angle) and the auxiliary wheels are placed in ground contact having a separation corresponding to the acceleration forward (opposite direction to that of acceleration) of the drive wheels. In this manner, the effect of the anti-torque of the drive wheels and the inertial force due to the acceleration or deceleration is cancelled out and balance of the vehicle body is maintained by the normal force at the point of ground contact of the auxiliary wheels and the gravitational torque resulting from vehicle body inclination. In this state, the auxiliary wheels are placed in ground contact at a position which is separated forward by a fixed amount by expanding the rear rod actuator R63 more than the forward rod actuator R62. In this manner, the auxiliary wheels can be placed in ground contact at an arbitrary position by adjusting the amount of extension or compression of both rod actuators F62, R63.

When the auxiliary wheels 15 make ground contact at an arbitrary position, the auxiliary wheels can be slightly raised at that position by slightly compressing both rod actuators F62, R63 and placed in a standby non-ground contact state.

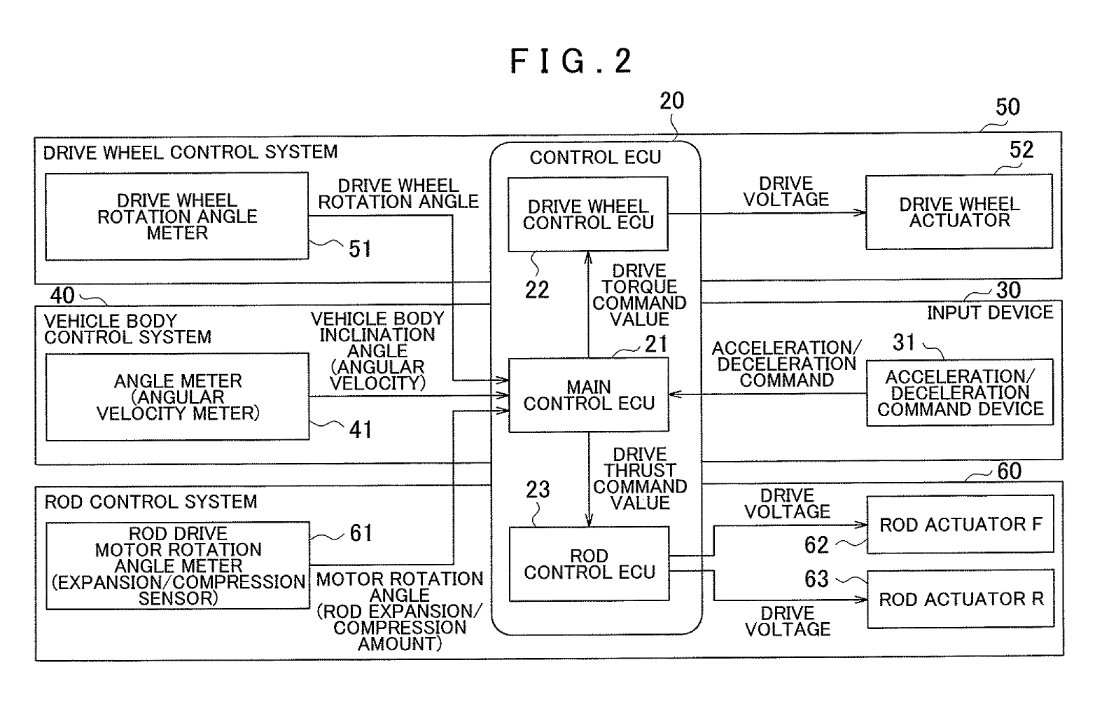

FIG. 2 shows the constitution of the control unit. The control unit includes a control electronic control unit (ECU) 20, an acceleration/deceleration command device 31, an angle meter (angular velocity meter) 41, a drive wheel rotation angle meter 51, a drive wheel actuator 52 (drive motor 12), a rod drive motor rotation angle meter (expansion/compression sensor) 61, rod actuators F62, R63 and other devices.

The control unit is provided with other devices such as batteries (not shown). The batteries can supply power for driving operations and calculation operations to the drive motor 12, the drive actuator 52, both rod actuators F62, R63 and the control ECU 20.

The control ECU 20 is provided with a main control ECU 21, a drive wheel control ECU 22 and a rod control ECU 23. Each type of control including vehicle running and posture control is performed by the drive wheel control or vehicle body control (inverted pendulum control). The control ECU 20 performs posture control using the auxiliary wheels 15 during acceleration and deceleration in this embodiment. The control ECU 20 is formed from a computer system including a ROM storing data and various programs, a RAM used as an operational section, an external memory device and an interface section.

The drive wheel rotation angle meter 51, the angle meter (angular velocity meter) 41, the rod drive motor rotation angle meter 61 and the acceleration/deceleration command device 31 as the input device 30 are connected to the main control ECU 21.

The acceleration/deceleration command device 31 is formed by a joystick for example and running commands based on an operation of an occupant are supplied to the main control ECU 21. An upright joystick position is a neutral position and commands acceleration by tilting in a longitudinal direction and commands a turning curve by tilting to the right or left. When the angle of inclination increases, the requested acceleration/deceleration or turning curve increases.

The main control ECU 21 functions as a vehicle body control system 40 together with the angle meter 41 and posture control of the inverted pendulum vehicle is performed by controlling vehicle body posture with the anti-torque of the drive motor 12 based on vehicle body inclination.

The main control ECU 21 functions as a drive wheel control system 50 together with the drive wheel control ECU 22, the drive wheel rotation angle meter 51, and the drive wheel actuator 52.

The drive wheel rotation angle meter 51 supplies a rotation angle of the drive wheel 11 to the main control ECU 21. The main control ECU 21 supplies a drive torque command value to the drive wheel control ECU 22 and the drive wheel control ECU 22 supplies a drive voltage corresponding to the drive command value to the drive wheel actuator 52. The drive wheel actuator 52 controls both drive wheels 11a, 11b independently according to the command value.

The main control ECU 21 functions as drive wheel torque determination means. The main control ECU 21 also functions as a rod control system 60 (ground contact member control means) together with the rod control ECU 23, the rod drive motor rotation angle meter (expansion/compression sensor) 61 and rod actuators F62, R63.

The rod drive motor rotation angle meter 61 supplies a rotation angle of a rod drive motor, that is to say, the compression/expansion amount λ_{F}, λ_{R} of both rod actuators to the main control ECU 21. The main control ECU 21 supplies a drive thrust command value to the rod control ECU 23. The rod control ECU 23 supplies a drive voltage corresponding to the drive thrust command value respectively to both rod actuators F62, R63. Both rod actuators F62, R63 undergo compression and expansion in response to the command value and in this manner enables switching of the ground contact or non-ground contact and movement of the auxiliary wheels 15 to the predetermined position.

Assist wheel control will be described with respect to acceleration in the vehicle according to the present embodiment constituted as described above. Although there are cases in which the acceleration requested by the input device will be positive (acceleration) and negative (deceleration), since both are subject to the same control with the direction reversed, the description below will describe negative acceleration, that is to say, an example of deceleration will be described.

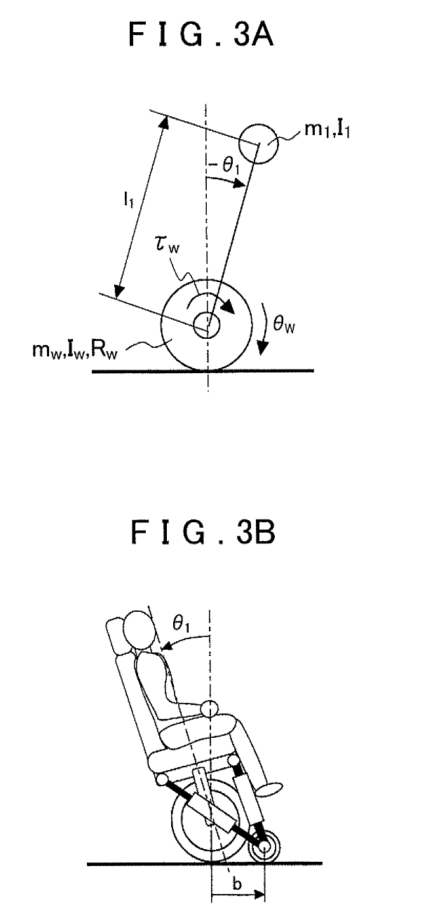

FIGS. 3A and 3B show dynamic models for a vehicle posture control system according to the present embodiment. The reference numerals in FIGS. 3A and 3B are as follows and the reference numeral in each embodiment below are those reference numerals corresponding to the dynamic model.

### (a) State Quantities

θ_{w}: rotational angle of drive wheels [rad]
θ₁: angle of inclination of main body (vertical axis standard) [rad]
b: distance between the ground contact points of the auxiliary wheels and drive wheels (wheel base) [m]
λ_{F}: expansion/compression amount of rod actuator F
λ_{R}: expansion/compression amount of rod actuator R

### (b) Input Force

τ_{W}: drive motor torque (2-wheel total) [Nm]
T_{F}: thrust of rod actuator F [N]
T_{R}: thrust of rod actuator R [N]

### (c) Physical Constants

g: gravitational acceleration [m/s²]

### (d) Parameter

m_{W}: mass of drive wheels [kg]
R_{W}: radius of drive wheels [m]
I_{W}: inertial moment of drive wheels (about wheel shaft) [kgm²]
r_{W}: radius of auxiliary wheels [m]
m₁: mass of main body (including occupant) [ ]
I₁: distance of center of gravity of main body (from wheel shaft) [m]
I₁ inertial moment of main body (about center of gravity) [kgm²]

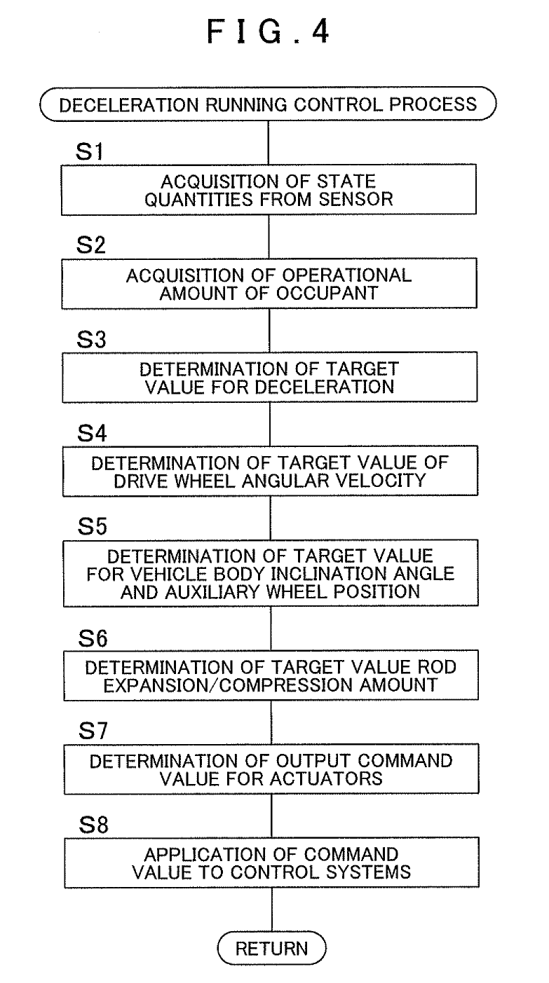

FIG. 4 is a flowchart showing a deceleration running control process according to a first embodiment.

The main control ECU 21 acquires the respective state quantities from a sensor (step 1). In other words, the main control ECU 21 acquires a drive wheel rotation angle θ_{W} from the drive wheel rotation angle meter 51, a vehicle body inclination angle θ₁ (angular velocity) from the angle meter (angular velocity meter) 41 and a rotation angle (expansion/compression amount λ_{F}, λ_{R}) from the rod drive motor rotation angle meter (expansion/compression sensor) 61.

The main control ECU 21 acquires an operational amount of an occupant inputted from an acceleration/deceleration command device 31 (for example a joystick operational amount) (step 2) and determines a target value α* for deceleration based on the operational amount (step 3). The target value α* for deceleration is determined to be a value proportional to the acquired operational amount, for example.

Next, the main control ECU 21 determines a target value {θ_{w}*} for drive wheel angular velocity from the target value α* for deceleration determined in step 3 (step 4). The target value {θ_{w}*} for drive wheel angular velocity is a value obtained by converting an acceleration to a velocity by time integration of the target value α* for deceleration and then dividing that value by a predetermined drive wheel ground contact radius R_{W}. The symbol {X} expresses a time differential for X.

Next the main control ECU 21 determines a target value θ₁* for a vehicle inclination angle from Formula 1 and determines a target value b* for auxiliary wheel position from Formula 2 (step 5). In other words, the main control ECU 21 determines a required target value θ₁* for a vehicle inclination angle and a target value b* for auxiliary wheel position to realize the deceleration at the target value α* for deceleration determined in step 3.

When α*<α_{Max}, θ₁*=φ*+sin⁻¹(tan γ sin φ*)

When α*≧α_{Max}, θ₁*=θ_{1,Max} Formula 1

When α*<α_{Max}, b*=0

When α*≧α_{Max}, b*=C_{safe}b₀* Formula 2

In Formula 1, φ* is an equilibrium axis inclination angle, and is given as φ*=tan⁻¹α*. When the value for the deceleration target α* increases, φ* increases.

In Formula 2, b₀* is a slip limit auxiliary wheel position and is a function of the deceleration target α*. When the deceleration target α* increases, the value for b₀* increases (refer to Formula 2-2 hereafter).

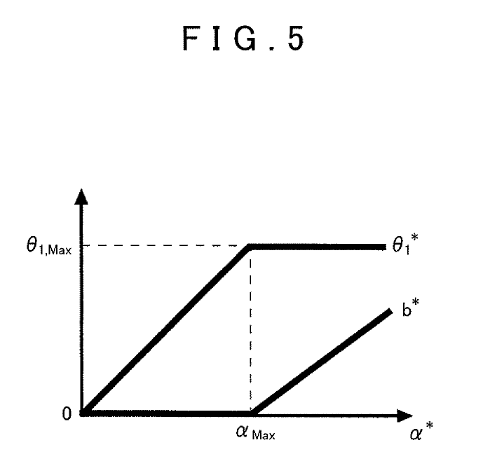

FIG. 5 shows the relationship between the target value θ₁* for a vehicle inclination angle and the target value b* for auxiliary wheel position relative to the target value α* for deceleration determined in step 3 (Formula 1, Formula 2). As shown in FIG. 5 and Formula 1, when the target value α* for deceleration is less than a threshold α_{Max}, the target value θ₁* for a vehicle inclination angle increases up to a maximum vehicle body inclination angle α_{Max} (set value) as the value for the target value α* increases. On the other hand, when the target value α* for deceleration is greater than or equal to the threshold α_{Max}, the target value θ₁* takes the maximum vehicle body inclination angle θ_{1Max} and the vehicle body does not incline greater than that value.

As shown in FIG. 5 and Formula 2, when the target value α* for deceleration is less than a threshold α_{Max}, the target value b* for auxiliary wheel position is determined to be zero. When the target value α* is greater than or equal to the threshold α_{Max}, the target value b* for auxiliary wheel position increases together with the target value α*.

In this manner, when the target value α* for deceleration is less than a threshold α_{Max}, the vehicle body inclines within the range defined by the maximum vehicle body inclination angle θ_{1,Max} and the balance of the vehicle body is maintained during deceleration by displacement of the center of gravity due to the vehicle inclination. Within this range, the auxiliary wheels 15 are not in ground contact and elimination of unnecessary ground contact of the auxiliary wheels 15 enables a reduction in energy loss resulting from ground contact of the auxiliary wheels 15. On the other hand, when the target value α* for deceleration is greater than or equal to the threshold α_{Max}, the target value θ₁* for the angle of inclination of the vehicle body is maintained to the maximum vehicle body inclination angle θ_{1,Max}. Since vehicle balance during deceleration is not maintained by only displacement of the center of gravity due to the vehicle inclination, the vehicle body inclines forward and thereafter the shortfall in the inclining torque is compensated for by the normal force at the point of ground contact of the auxiliary wheels 15.

A wheelbase b corresponding to the target value α* is set by increasing the target value b* for the auxiliary wheel position together with the target value α* for deceleration. In this manner, forward inclination of the vehicle body when the target value α* for deceleration is large, or slip resulting from a decrease in the ground contact load of the drive wheels can be prevented.

In Formula 1 and Formula 2, the threshold α_{Max} is determined from Formula 1-2 below using the predetermined maximum vehicle body inclination angle θ_{1Max}. Tan γ in Formula 2 is determined from Formula 1-3 and the value M in Formula 1-3 is determined from Formula 1-4.

α_{Max}=(sin θ_{1,Max})/(cos θ_{1,Max}+tan γ) Formula 1-2

tan γ=(MR_{W})/(m₁lₜ) Formula 1-3

M=m₁+m_{w}+I_{w}/R_{w}² Formula 1-4

In Formula 2, b₀* is the auxiliary wheel position at the slip limit and is expressed in Formula 2-2, and M_{b}* is expressed in Formula 2-3.

Idle rotation of the drive wheels can be suppressed by applying a safety coefficient C_{safe} with respect to the auxiliary wheel position at the slip limit b₀* whereby safety is ensured. The slip limit is determined with respect to the static friction coefficient μ between the drive wheels and the road surface (predetermined measurement value). The safety coefficient C_{safe} is a predetermined set value.

b₀*=l₁(m₁/M_{b}*)(tan γ sin φ*+sin(φ*−θ_{1,Max}))/cos φ* Formula 2-2

M_{b}*=(1−(α*/μ))M Formula 2-3

The main control ECU 21 displaces the auxiliary wheels 15 towards the target value b* for auxiliary wheel position determined by Formula 2 and therefore that value is used to determine the target values λ_{F}*, λ_{R}* for the rod expansion/contraction amount relative to the rod actuator F62, R63 are determined from Formula 3 below (step 6).

In Formula 3, ε is determined from Formula 3-2 and λ₀ is determined from Formula 3-3. Formula 3

λ_{F}*=√((d cos θ_{1,Max}−h sin θ_{1,Max}−b*)²+(h cos θ_{1,Max}+d sin θ_{1,Max}+R_{W}−r_{W}+ε)²)−l₀

λ_{R}*=√((d cos θ_{1,Max}−h sin θ_{1,Max}−b*)²+(h cos θ_{1,Max}+d sin θ_{1,Max}+R_{W}−r_{W}+ε)²)−l₀

When b*=0, ε=−δ,

When b*>0, ε=0, Formula 3-2

l₀=√(d²(h+R_{W}r_{W})²) Formula 3-3

In Formula 3-2, δ is a minute contraction amount for lifting the auxiliary wheels 15 from the ground contact surface. In other words, when target value α*<threshold α_{Max} (b*=0), from Formula 3, the auxiliary wheels 15 are placed into a standby position not making ground contact at the position δ directly above the ground contact position nearest to the drive wheel 11.

Although the contraction amount δ in the present embodiment is arbitrary, it can be set to 5 mm or 1 cm for example. The contraction amount δ may be a value which differs in response to the state of the road surface such as a paved road or an unpaved road. In this case, the state of the road is determined from a vibration state detected by a vibration sensor. The amplitude of the vibration may be detected, and a variation can be performed to increase the contraction amount δ in response to the amplitude. Furthermore a corresponding contraction amount δ may be employed by the occupant inputting paved road or unpaved road.

In Formula 3-3, l₀ is the reference length of both rod actuators F62, R63. When the posture of the vehicle is upright, a state in which the auxiliary wheels 15 make ground contact directly below the drive shaft of the drive wheel 11 is taken to be a reference state and the length of the rod at the reference state is taken to be l₀. The difference from the reference length l₀ is taken to be the rod expansion/contraction amount λ. The symbol d denotes the value when the distance between the ends (fixed points) 62a, 63a on the riding section 13 side of the rod actuators F62, R63 takes a value of 2d. h is the distance from the median point of both fixed points 62a, 63a to the rotational center of the drive wheels 11.

The structure of the rod actuators F62, R63 in the present embodiment is an example of an auxiliary wheel position control structure and another structure may be employed. For example, one end of the rod actuator may be mounted on the vehicle body such as the seat cushion 131 and the ground contact of the auxiliary wheels 15, the non-ground contact and the ground contact position may be varied by using the drive motor to adjust the expansion/contraction amount and the angle of the rod. In this case, a target value corresponding to that structure is set in place of Formula 3.

The main control ECU 21 determines the output command value for each actuator (step 7). In other words, the main control ECU 21 determines a torque command value τ_{W} for the drive wheels 11 from Formula 4 and determines a drive thrust command value T_{F}, T_{R} for both rod actuators F62, R63 from Formula 5.

In Formula 4, the target value {θ_{W}*} for the drive wheel angular velocity determined in step 4 and the target value θ₁* for the vehicle body angle of inclination determined in step 5 are used.

In the Formula 5, the target values λ_{F}*, λ_{R}* for the rod expansion/contraction amount determined in step 6 are used.

τ_{W}=−K_{W2}([θ_{W}]−[θ_{W}*]−K_{W3}(θ₁−θ₁*)−K_{W4}([θ₁]−[θ₁*]) Formula 4

T_{F}=−K_{L1}(λ_{F}−λ_{F}*)−K_{L2}([λ_{F}]−[λ_{F}*])−K_{L3}∫(λ_{F}−λ_{F}*)dt

T_{R}=−K_{L1}(λ_{R}−λ_{R}*)−K_{L2}([λ_{R}]−[λ_{R}*])−K_{L3}∫(λ_{R}−λ_{R}*)dt Formula 5

In Formulas 4 and 5, the feedback gain values K_{W2}, K_{W3}, K_{W4} and K_{L1}, K_{L2}, K_{L3} are set in advance using a pole assignment method, for example. In Formula 4, when the auxiliary wheels 15 are in ground contact, the feedback gain may have a value of K_{W3}=K_{W4}=0 such that inverted pendulum posture control is not performed.

In Formula 5, the effect of gravity or dry friction is compensated for by applying an integral gain K_{L3}. However in a feedforward sense, provision may be made for input application.

The main control ECU 21 applies the respective command values to each control system and returns to the main routine (step 8). In other words, the main control ECU 21 supplies a torque command value τ_{W} for the drive wheels 11 to the drive wheel control ECU 22 and supplies the drive thrust command value T_{F}, T_{R} for both rod actuators F62, R63 to the rod control ECU 23. In this manner, the drive wheel control ECU 22 supplies a drive voltage corresponding to the command value τ_{W} to the drive wheel actuator 52, applies the drive torque τ_{W} to the drive wheels 11 and performs feedback control to coincide with the target value {θ_{W}*} for drive wheel angular velocity and the target value θ₁* for vehicle body angle of inclination determined in step 4.

The rod control ECU 23 supplies the drive voltage corresponding to the drive thrust command value T_{F}, T_{R} to both rod actuators F62, R63 and performs feedback control to coincide with the target value λ_{F}*, λ_{R}* for the rod extension/contraction amount determined in step 6. In this manner, the position of the auxiliary wheels 15 coincides with the target value b* for the auxiliary wheel position determined in the step 5.

A second embodiment will be described below.

In the first embodiment, the maximum vehicle body angle of inclination θ_{1,Max} determining the threshold α_{Max} are fixed values determined in advance by a designer. In contrast, in the second embodiment, the differences in a permissible range of vehicle body inclination for occupants are taken into account and the occupant can select the maximum vehicle body angle of inclination θ_{1,Max}. For example, control is performed to ensure balance to the greatest degree possible when the vehicle body is inclined by increasing the maximum vehicle body angle of inclination θ_{1,Max} (threshold α_{Max}). Conversely, for an occupant requiring running without inclination of the vehicle body, control is performed to maintain the posture to the greatest degree possible with the auxiliary wheels 15 by reducing the maximum vehicle body angle of inclination θ_{1,Max} (threshold α_{Max}). Thus an inverted pendulum vehicle is realized by limiting the vehicle body angle of inclination in accordance with the preferences of an occupant.

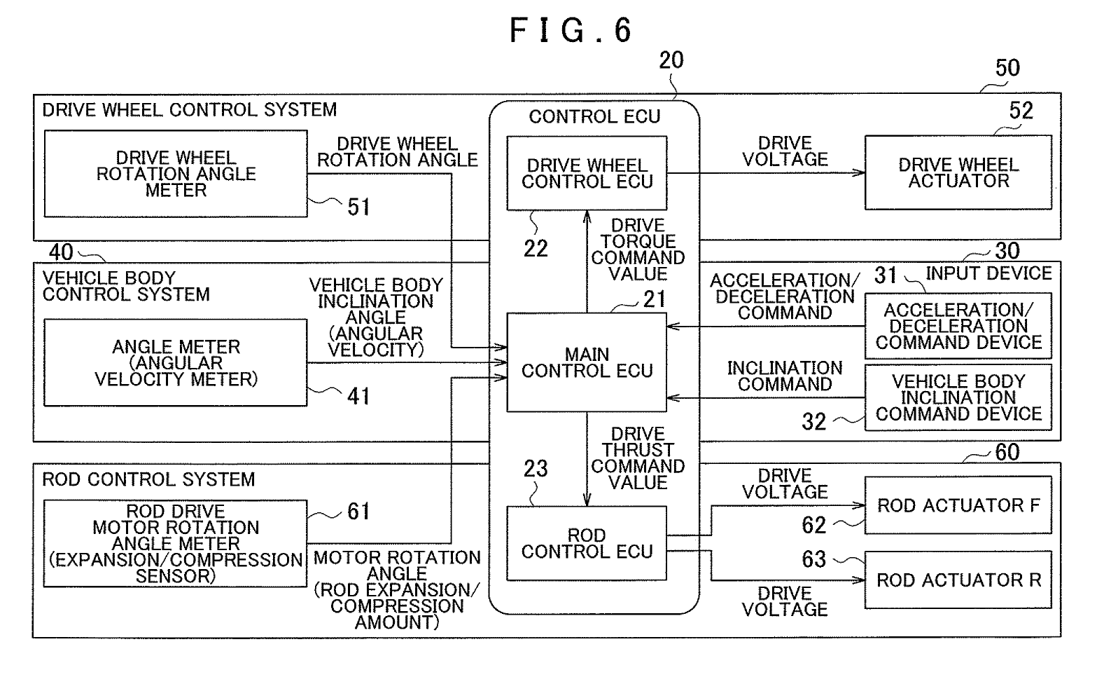

FIG. 6 shows the structure of a control unit according to the second embodiment. The control unit according to the second embodiment includes a vehicle body inclination command device 32 in the input device 30. The vehicle body inclination command device 32 is an input device for indication of occupant preferences with respect to inclination of the vehicle body. The operational amount is supplied to the main control ECU 21 as an inclination command.

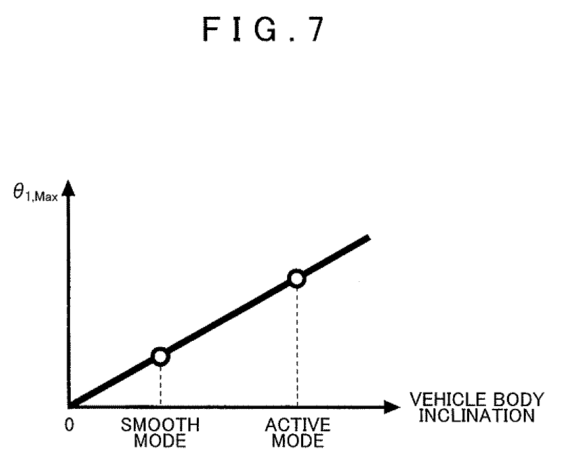

FIG. 7 shows the relationship between the inclination command supplied from the vehicle body inclination command device 32 and the maximum vehicle body inclination angle θ_{1,Max}. The main control ECU 21 has a corresponding conversion table or a corresponding conversion formula to FIG. 7 in a predetermined storage section which is used to determine the maximum vehicle body inclination angle θ_{1,Max}. In the present embodiment, as shown by the solid line in FIG. 7, although the occupant can select an arbitrary value from 0 to a maximum value as a vehicle body inclination angle, a system may be provided enabling selection of a discrete vehicle body inclination angle. For example, a selection may be enabled with respect to two modes being a smooth mode having a small value for the maximum vehicle body inclination angle θ_{1,Max} or an active mode with a large value for the maximum vehicle body inclination angle θ_{1,Max}. Furthermore selection of more stages may be enabled. When selection of a discrete maximum vehicle body inclination angle θ_{1,Max} is enabled, the value for the maximum vehicle body inclination angle θ_{1,Max} corresponding to the selectable mode or the vehicle body inclination is pre-stored. Other constituent sections of the control unit according to the second embodiment are the same as those of the first embodiment as shown in FIG. 2.

Next the operation of the second embodiment will be described.

In addition to a deceleration running process performed in this embodiment, the main control ECU 21 monitors whether or not an inclination command value has been supplied from the vehicle body inclination command device 32 in accordance with an input of a vehicle body inclination angle by an occupant. When the inclination command is supplied, the vehicle body inclination value is stored in a storage section such as a RAM. The vehicle body inclination command may be stored in a non-volatile storage section rather than a RAM, and once inputted, the vehicle body inclination command may be used continuously with respect to subsequent running operations. Of course, when the occupant changes, a new vehicle body inclination may be inputted by the new occupant and in this case, the data in the storage section can be updated. Vehicle body inclination commands may be stored for respective occupants by discriminating between the occupants. In this case, a load meter is disposed on the seat cushion 131 to infer an occupant from a measured load or the occupant may input their own discrimination data.

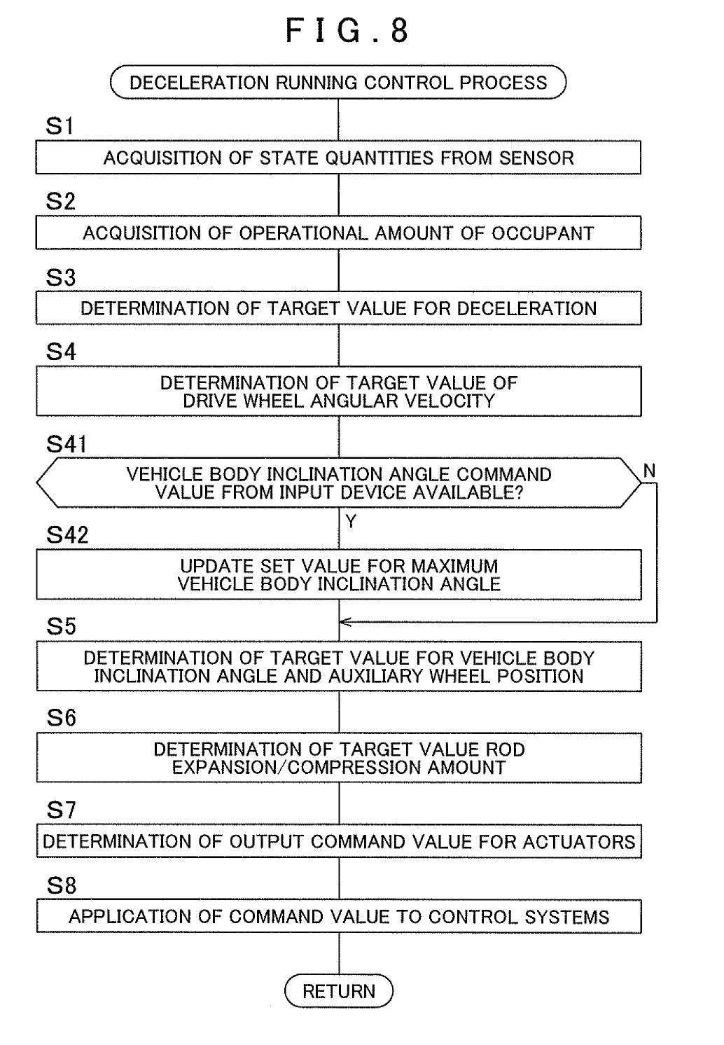

FIG. 8 is a flowchart showing the details of a deceleration running control process according to the second embodiment. Sections which are the same as those processes described in the first embodiment with reference to the flowchart in FIG. 4 including the embodiment below are designated by the same step numbers, additional description will be omitted and the description will concentrate on points of difference.

In the same manner as the first embodiment, the main control ECU 21 acquires respective state quantities θ_{W}, θ₁, λ_{F}, λ_{R} from a sensor (step 1), acquires an operational amount from an occupant (step 2), determines a target value α* for deceleration (step 3) and determines a target value {θ_{W}*} for drive wheel angular velocity (step 4). The main control ECU 21 determines whether or not an inclination command value inputted from the vehicle body inclination command device 32 is present in the input device storage section (step 41).

When a vehicle body inclination command value is present in the input device storage section (step 41: Y), the main control ECU 21 determines a maximum vehicle body inclination angle θ_{1,Max} corresponding to the vehicle body inclination command value from the relationship shown in FIG. 8 and updates the value of the maximum vehicle body inclination angle used in Formula 1 and Formula 2 (step 42). On the other hand, when a vehicle body inclination command value is not present in the input device storage section (step 41: N), in other words, when the occupant has not set a vehicle body inclination by operation of the vehicle body inclination command device 32, the main control ECU 21 omits step 42 and proceeds to step 5. The value of the maximum vehicle body inclination angle θ_{1,Max} in this case is determined in the same manner as the first embodiment and is used as a default value.

Thereafter in the same manner as the first embodiment, the main control ECU 21 determines both the target values θ₁*, b* for the vehicle inclination angle and auxiliary wheel position (step 5), determines the target values λ_{F}*, λ_{R}* for the rod expansion/contraction amount (step 6), determines the output command values τ_{W}, T_{F}, T_{R} for each actuator (step 7) and supplies the respective command values τ_{W}, T_{F}, T_{R} to each control system (step 8) and then returns to the main routine.

Next a third embodiment will be described.

As described with reference to the first embodiment, the auxiliary wheels 15 are displaced to a target position b* by feedback control. As a result, when a displacement lag is produced, since braking is applied before the auxiliary wheels 15 reach the target position b* for the auxiliary wheels, there is the possibility of temporary forward inclination of the vehicle body or drive wheel slip. Thus in the third embodiment, the target deceleration α* is limited until the auxiliary wheels 15 reach the target position b* with respect to “lags” in the displacement of the auxiliary wheels 15. More precisely, the target deceleration α* is limited by the actual auxiliary wheel position b. In this manner, loss of balance during deceleration due to vehicle body inclination and auxiliary wheel ground contact can be prevented and forward vehicle inclination and slip can be prevented. This serves as a failsafe if a system of displacing the auxiliary wheels 15 malfunctions.

The structure of the control unit according to the third embodiment is the same as that of the first embodiment shown in FIG. 2.

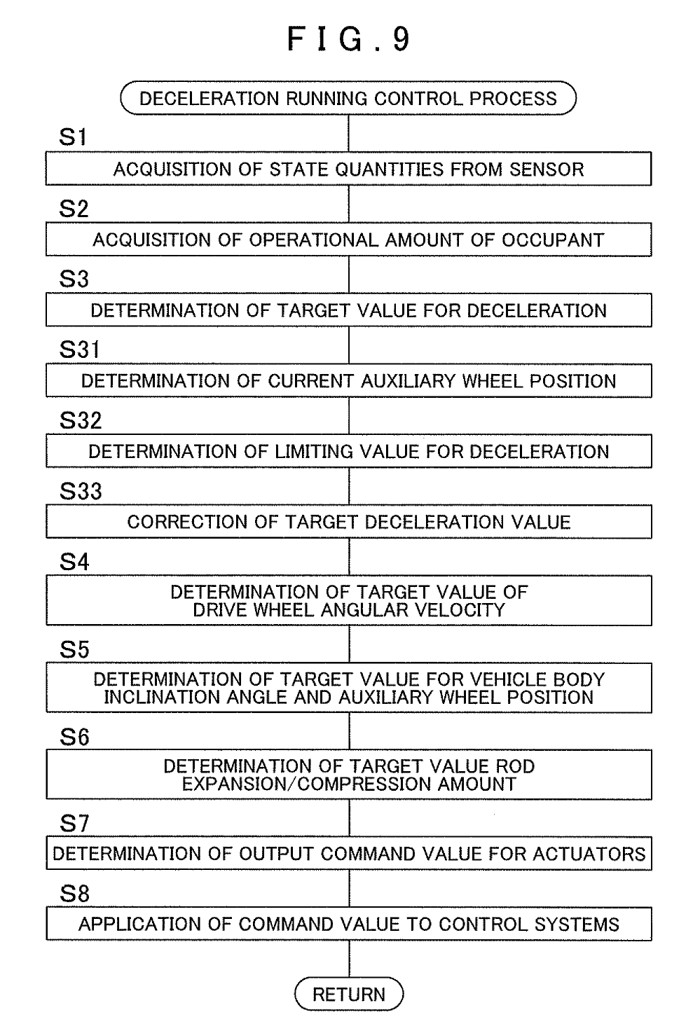

FIG. 9 is a flowchart showing the details of deceleration running control process according to the third embodiment.

In the same manner as the first embodiment, the main control ECU 21 acquires respective state quantities θ_{W}, θ₁, λ_{F}, λ_{R} from a sensor (step 1), acquires an operational amount from an occupant (step 2) and determines a target value f for deceleration (step 3).

The main control ECU 21 uses Formula 6 below to determine the current auxiliary wheel position b (step 31). Formula 6 corresponds to the auxiliary wheel position control mechanism (rod actuator F62, R63) shown in FIGS. 1A and 1B. As described in the first embodiment, when using another mechanism the auxiliary wheel position b is determined using an equation corresponding to the structure employed in substitution of Formula 6.

b=((λ_{R}−l₀)²−(λ_{F}−l₀)²)/(4d cos θ₁)+(R_{W}−r_{W})tan θ₁ Formula 6

Next the main control ECU 21 determines a limiting value αₗᵢₘ for deceleration corresponding to the current auxiliary wheel position b (step 32). Tan η in Formula 7 is determined from Formula 7-2 using the current auxiliary wheel position b and M_{b} is determined using Formula 7-3.

αₗᵢₘ=(sin θ₁−tan η)/(cos θ₁+tan γ) Formula 7

tan η=(M_{b}b)/(m₁lₜ) Formula 7-2

M_{b}=(1−(α*/μ))M Formula 7-3

Although the deceleration limit αₗᵢₘ is defined with reference to the slip limit in the third embodiment, the deceleration limit may be defined with reference to the overturning limit. In this case, M_{b}=M in Formula 7-3. Control stability may be increased by dividing the deceleration limit obtained by Formula 7 by a safety coefficient.

When the deceleration limiting value determined in response to the current auxiliary wheel position b is smaller than the target value α* for deceleration determined in step 3, the main control ECU 21 performs a reduction operation to the limiting value αₗᵢₘ which determined the target value α* for deceleration in step 4 (step 33). For example, when the limiting value αₗᵢₘ for deceleration corresponding to the current auxiliary wheel position b takes a value of 0.3 G at a deceleration determined in step 3 of 0.4 G, the target value α* for deceleration used in step 4 is reduced to 0.3 G.

The main control ECU 21 determines a target value {θ_{W}*} for the drive wheel angular velocity from the target value α* for deceleration corrected in step 33 (step 4). In the same manner as the first embodiment, the main control ECU 21 thereafter determines both the target values θ₁*, b* for the vehicle inclination angle and auxiliary wheel position (however in this case, the value α* uses the deceleration target value before limiting determined in step 3) (step 5), determines the target values λ_{F}*, λ_{R}* for the rod expansion/contraction amount (step 6), determines the output command values τ_{W}, T_{F}, T_{R} for each actuator (step 7) and supplies the respective command values τ_{W}, T_{F}, T_{R} to each control system (step 8) and then returns to the main routine.

Next a fourth embodiment will be described.

In the fourth embodiment, when slip in the drive wheels 11 is detected by slip detection means, the ground contact position of the auxiliary wheels 15 displaces forward while maintaining the vehicle body angle of inclination. In this manner, the vehicle can emerge from a slip condition since the vehicle body center of gravity undergoes relative displacement from the auxiliary wheels 15 towards the drive wheel 11 and the ground contact load of the drive wheels 11 is increased. The structure of the control unit in the fourth embodiment is the same as that of the first embodiment shown in FIG. 2.

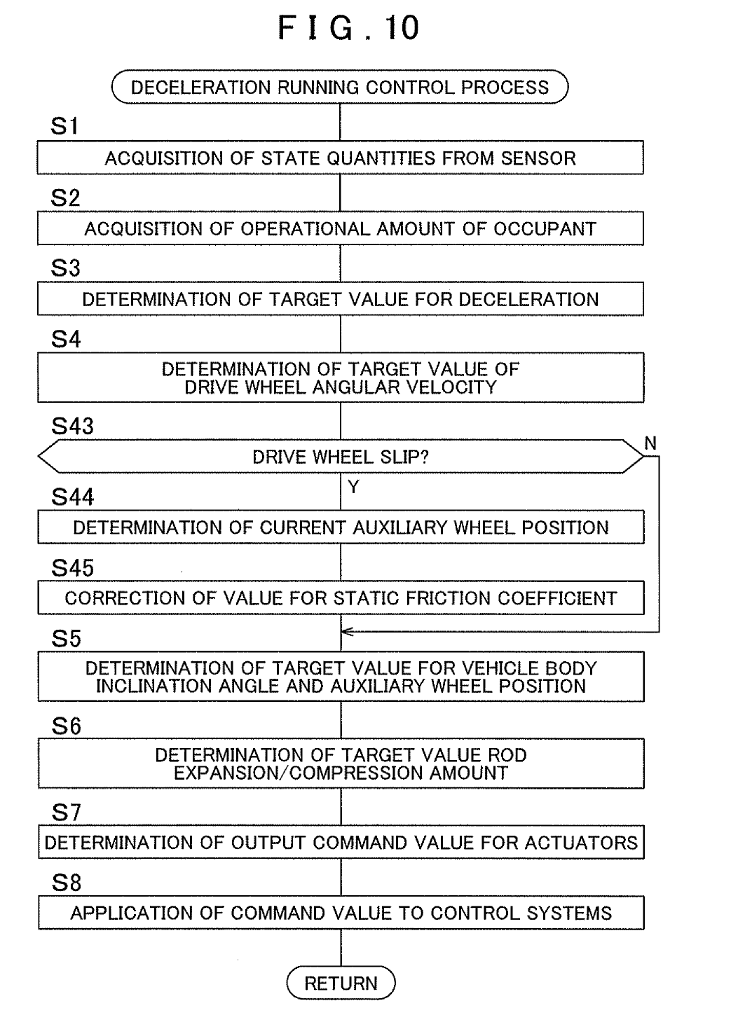

FIG. 10 is a flowchart showing the details of a deceleration running control process according to the fourth embodiment.

In the same manner as the first embodiment, the main control ECU 21 acquires respective state quantities θ_{W}, θ₁, λ_{F}, λ_{R} from a sensor (step 1), acquires an operational amount from an occupant (step 2), determines a target value α* for deceleration (step 3) and determines a target value {θ_{W}*} for drive wheel angular velocity (step 4).

The main control ECU 21 determines whether or not the drive wheels 11 are in a state of slip (step 43). The method of determining whether or the drive wheels 11 are in a state of slip includes determination using a method employing an observer based on a dynamic model with respect to rotational motion of the drive wheels and a method of comparing the rotation speed of the drive wheels 11 with a value from an acceleration sensor mounted on the vehicle.

Next the main control ECU 21 determines the current auxiliary wheel position b (step 44). The process is the same as step 31 in the third embodiment. The main control ECU 21 determines the current auxiliary wheel position b from Formula 6. The main control ECU 21 corrects the value for coefficient of static frictional μ used in Formulas 2 and 3 to a value obtained from Formula 8 (step 45).

μ=α/(1−(m₁lₜ/Mb)((cos θ₁+tan γ)α−sin θ₁)) Formula 8

Acceleration a in Formula 8 is obtained from a history of drive wheel rotation speed immediately prior to slip or from a value from an acceleration sensor mounted on the vehicle. The estimation method (estimation value) may be stabilized by applying the calculation result from Formula 8 to a low pass filter.

In the same manner as the first embodiment, the main control ECU 21 thereafter determines both the target values θ₁*, b* for the vehicle inclination angle and auxiliary wheel position (step 5), determines the target values λ_{F}*, λ_{R}* for the rod expansion/contraction amount (step 6), determines the output command values τ_{W}, T_{F}, T_{R} for each actuator (step 7) and supplies the respective output command values τ_{W}, T_{F}, T_{R} to each control system (step 8) and then returns to the main routine.

In the fourth embodiment, once the vehicle has slipped, when the estimated value for the coefficient of static friction is decreased, as long as a single cycle of control is not completed the value is not recovered. A reset signal transmission device may be provided to the input device and a value may be initialized using the input signal. Otherwise the value may be gradually recovered over the course of time.

Next a fifth embodiment will be described.

The fifth embodiment is a process for dealing with emergency braking operations. During emergency braking, a large braking force is required in addition to deceleration in as short a time as possible. During deceleration, although balance of the drive wheels 11 is maintained by tilting the vehicle rearward, the vehicle is temporarily accelerated by the reactive force of the drive wheel torque tilting the vehicle body rearward and the period of rearward tilting of the vehicle body results in a time loss until commencement of emergency braking. In the fifth embodiment, during emergency braking, running control (deceleration control) is prioritized over vehicle body posture control. More precisely, when a request for emergency braking is detected, the vehicle is deceleration while maintaining vehicle posture by placing the auxiliary wheels 15 in immediately ground contact with the target position without inclining the vehicle body to the rear.

The structure of the control unit according to the fifth embodiment is the same as that of the first embodiment shown in FIG. 2.

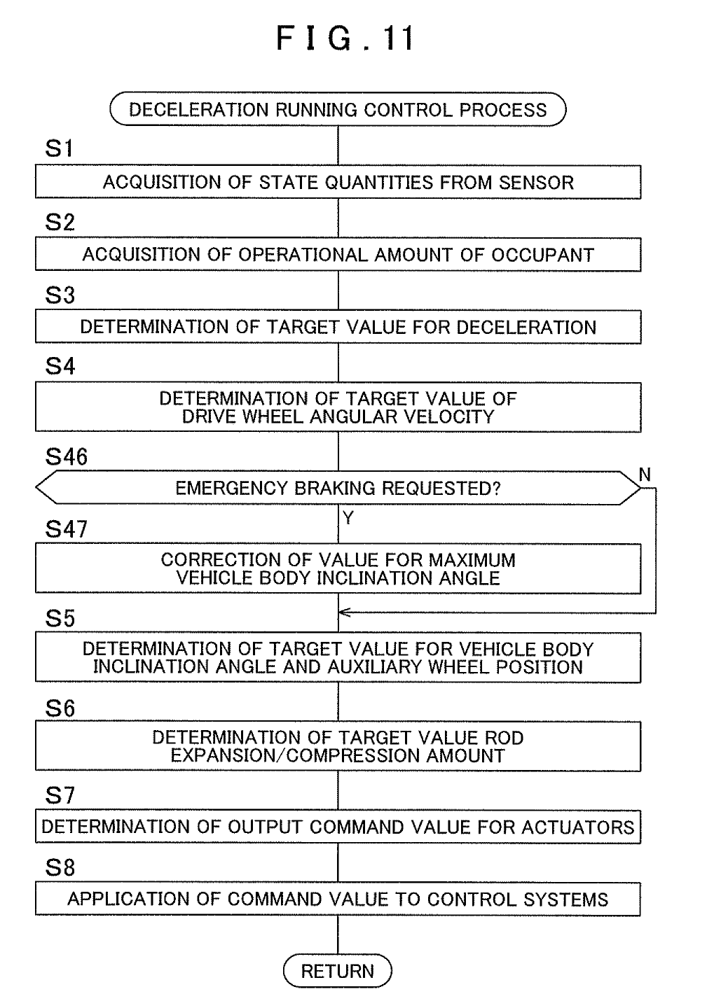

FIG. 11 is a flowchart showing the details of deceleration running control process according to the third embodiment.

In the same manner as the first embodiment, the main control ECU 21 acquires respective state quantities θ_{W}, θ₁, λ_{F}, λ_{R} from a sensor (step 1), acquires an operational amount from an occupant (step 2), determines a target value a for deceleration (step 3) and determines a target value {θ_{W}*} for drive wheel angular velocity (step 4).

The main control ECU 21 determines whether or not an occupant has requested emergency braking (step 46). Although the determination of whether an occupant has requested emergency braking is determined from the acceleration/deceleration command value supplied from the input device 30 or the variation rate of that value, it may be determined from a signal from an emergency braking command input device in the input device 30.

When emergency braking is not requested (step 46: N), the main control ECU 21 proceeds the routine to step 5 and in this case, the same processing as the first embodiment is applied. On the other hand, when emergency braking is requested (step 46: Y), the main control ECU 21 corrects the maximum vehicle body inclination angle θ_{1,Max} used in Formula 1 and Formula 2 to θ_{1,Max}=0. In this manner, the target value θ₁* for vehicle body inclination angle takes a value of 0, thus time loss and temporary acceleration resulting from vehicle body inclination can be eliminated.

In the same manner as the first embodiment, the main control ECU 21 determines both the target values θ₁*, b* for the vehicle inclination angle and auxiliary wheel position from Formula 1 and Formula 2 (the value θ_{1,Max} for is varied with respect to the present or absence of a correction) (step 5), determines the target values λ_{F}*, λ_{R}* for the rod expansion/contraction amount (step 6), determines the output command values τ_{W}, T_{F}, T_{R} for each actuator (step 7) and supplies the respective output command values τ_{W}, T_{F}, T_{R} to each control system (step 8) and then returns to the main routine.

In the fifth embodiment described above, during emergency braking, the target value θ₁* for vehicle body inclination angle is placed to a value of 0 and deceleration is enabled while maintaining an upright posture with the auxiliary wheels 15. However deceleration may be enabled while tilting forward by placing the target value θ₁* for vehicle body inclination angle to a negative value. In this manner, the reactive force with respect to the vehicle body forward tilting torque can be compensated for as deceleration torque. Posture control may not be performed (waived) by placing the feedback gain KW₃, KW₄ in Formula 4 to a value of zero.

In each of the embodiments above, as shown in FIG. 5 and expressed in Formula 2, when the target value α* for deceleration is greater than or equal to the threshold α_{Max}, although the target value b* for auxiliary wheel position can be increased together with the target value α* for deceleration, the target value b* may be a fixed value. In other words, in Formula 2, if b* is placed to a value of b₀ when α*≧α_{Max}, in the event that the target value α* for deceleration is greater than or equal to the threshold α_{Max}, the auxiliary wheels 15 make ground contact with a position b₀ at a predetermined distance from the drive wheel 11 in a forward position during deceleration or a rear position during acceleration. A value for a position corresponding to the value of maximum envisaged acceleration or deceleration, for example, can be applied in advance as the predetermined value b₀. There is no necessity for the auxiliary wheels 15 to displace forward or to the rear by an arbitrary amount in response to the acceleration or deceleration. For example, retractable auxiliary wheels 15F, 15R may be disposed respectively at a front or back position corresponding to the maximum envisaged acceleration or deceleration.

In each of the embodiments described above, the target position for the auxiliary wheels when not in ground contact is given by b*=0 (Formula 2). The auxiliary wheels 15 are usually in a standby position δ directly above a ground contact position nearest to the drive wheels 11 with respect to an arbitrary vehicle body angle of inclination θ₁ of target value α* for deceleration<threshold value α_{Max} (Formula 3). Thus when required, ground contact at a suitable position may be rapidly performed for early enablement of the effect of ground contact by the auxiliary wheels 15. In this regard, the standby position of the auxiliary wheels may be varied in response to the running velocity of the vehicle in order to adapt rapidly to variation in acceleration or deceleration. For example, when the vehicle is stationary, sharp acceleration may be provided for by moving the auxiliary wheels in a rear direction in advance or when running at near to maximum velocity, sharp braking may be provided for by moving the auxiliary wheels forward in advance.

Furthermore energy saving may be realized by not performing any control of the auxiliary wheels standby position when the vehicle is not in use.

1. An inverted pendulum vehicle comprising:
drive wheels coaxially disposed at opposing ends of an axle;
a vehicle body having a riding section;
acceleration request acquisition means for receiving a requested acceleration for the vehicle;
running control means for maintaining the vehicle body, including the riding section, upright by controlling torque to in the drive wheels and running in response to the requested acceleration;
a ground contact member disposed to be switchable between a ground contact state and a non-ground contact state at a position forward or rearward of the drive wheels; and
ground contact member control means for extending the ground contact member into ground contact in a direction opposite to the direction of acceleration of the drive wheels when the absolute value of the requested acceleration is greater than or equal to a predetermined threshold.

2. The inverted pendulum vehicle according to claim 1 wherein:
the ground contact member control means places the ground contact member in ground contact at a position further from the drive wheels as an absolute value of the requested acceleration increases.

3. The inverted pendulum vehicle according to claim 1 wherein:
the ground contact member control means, when the ground contact member is in the non-ground contact state, places the ground contact member in a standby position by lifting the ground contact member by a predetermined distance at a position on a vertical line passing through a rotational axis of the drive wheels, or at a ground contact position when the absolute value of the requested acceleration is a predetermined threshold.

4. The vehicle according to claim 1 further comprising:
selection means for selecting a maximum value for a vehicle body angle of inclination; and wherein:
the ground contact member control means makes an acceleration corresponding to a maximum value of the selected vehicle body angle of inclination coincide with the predetermined threshold.

5. The vehicle according to claim 1 further comprising:
slip detecting means for detecting slip of the drive wheels when the ground contact member is in ground contact; and wherein:
the ground contact member control means, when slip in the drive wheels is detected, displaces the ground contact member in a direction away from the drive wheels.

6. An inverted pendulum vehicle comprising:
drive wheels coaxially disposed at opposing ends of an axle;
a vehicle body having a riding section;
acceleration request acquisition means for acquiring a requested acceleration for the vehicle;
running control means for maintaining the vehicle body, including the riding section, upright by controlling torque in the drive wheels and running in response to the requested acceleration;
a ground contact member selectively movable, between a ground contact state and a non-ground contact state, to a position forward or rearward of the drive wheels;
ground contact member control means for placing the ground contact member in ground contact in a direction opposite to the direction of acceleration of the drive wheels when the absolute value of the requested acceleration is greater than or equal to a predetermined threshold;
position acquisition means for acquiring a position of the ground contact member when grounded; and
correction means for correcting the requested acceleration, used by the running control means, to a value equal to or less than a limiting acceleration when the absolute value of the limiting acceleration corresponding to the position of the ground contact member is smaller than the absolute value of the requested acceleration.

7. The inverted pendulum vehicle according to claim 6 wherein:
the ground contact member control means places the ground contact member in ground contact at a position further away from the drive wheels as the absolute value of the acceleration acquired increases.

8. The vehicle according to claim 6 wherein:
the ground contact member control means, when the ground contact member is in the non-ground contact state, places the ground contact member in a standby position by lifting the ground contact member by a predetermined distance from a position on a vertical line passing through a rotational axis of the drive wheels, or from a ground contact position when the absolute value of the requested acceleration is a predetermined threshold.

9. The vehicle according to claim 6 further comprising:
selection means for selecting a maximum value of a vehicle body angle of inclination of the vehicle body; and wherein:
the ground contact member control means makes the acceleration corresponding to a maximum value of the selected vehicle body angle of inclination coincide with the predetermined threshold.

10. The vehicle according to claim 6 further comprising:
slip detecting means for detecting slip of drive wheels when the ground contact member is in ground contact; and wherein:
the ground contact member control means, when slip in the drive wheels is detected, displaces the ground contact member in a direction away from the drive wheels.

11. An inverted pendulum vehicle comprising:
drive wheels coaxially disposed at opposing end of an axle;
a vehicle body having a riding section;
acceleration request acquisition means for acquiring a requested acceleration for the vehicle;
running control means for maintaining the vehicle body, including the riding section, upright by controlling torque of the drive wheels and running in response to the requested acceleration;
a ground contact member selectively switchable between a ground contact state and a non-ground contact state in a position forward or rearward of the drive wheels; and
ground contact member control means for placing the ground contact member in ground contact in a direction opposite to the direction of acceleration of the drive wheels when the absolute value of the requested acceleration is greater than or equal to a predetermined threshold and when emergency braking is requested.

12. The inverted pendulum vehicle according to claim 11 wherein:
the ground contact member control means places the ground contact member in ground contact at a position further away from the drive wheels as the absolute value of the requested acceleration increases.

13. The inverted pendulum vehicle according to claim 11 wherein:
the ground contact member control means, when the ground contact member is in the non-ground contact state, places the ground contact member in a standby position by lifting the ground contact member by a predetermined distance at a position on a vertical line passing through rotational axis of the drive wheels, or at a ground contact position when the absolute value of the requested acceleration is a predetermined threshold.

14. The inverted pendulum vehicle according to claim 11 further comprising:
selection means for selecting a maximum value of an angle of inclination of the vehicle body; and wherein:
the ground contact member control means makes the acceleration corresponding to the maximum value of the selected vehicle body angle of inclination coincide with the predetermined threshold.

15. The inverted pendulum vehicle according to claim 11 further comprising:
slip detecting means for detecting slip of drive wheels when the ground contact member is in ground contact; and wherein:
the ground contact member control means, when slip in the drive wheels is detected, displaces the ground contact member in a direction away from the drive wheels.
